(19) United States
(12) Patent Application Publication
(10) Pub. No.: US 2011/0271265 A1
(43) Pub. Date: Nov. 3, 2011

(54) METHOD OF AUTOMATIC GENERATION OF EXECUTABLE CODE FOR MULTI-CORE PARALLEL PROCESSING

(76) Inventors: Alexander Y. Drozdov, Moscow (RU); Sergey V. Novikov, Sergiev Posad (RU)

(21) Appl. No.: 12/768,833

(22) Filed: Apr. 28, 2010

(51) Int. Cl. G06F 9/45

(52) U.S. Cl. 717/160

(57) ABSTRACT

A system, method and computer program product for optimizing the process of compilation of computer program code. The compiler transforms the program code written in a variety of languages and creates additional code performing parallel processing of program tasks on target hardware architecture. The transformation of code is performed to achieve optimization of various critical parameters such as the execution speed on a multi-core or cluster target hardware architecture.

### BACKGROUND OF THE INVENTION

1. Field of the Invention

The present invention is related to computer automation, and more particularly, to the transformation of source code of high level language program into a machine code (i.e., compilation) and optimization of the compilation process.

2. Description of the Related Art

The main role in effective utilization of hardware architecture suitable for explicitly parallel processing (multi-core, cluster, etc.) is, typically, played by the programming systems intended for creation of parallel programs. Such systems include computer language means for specifying tasks for parallel processing in the executable program (e.g., systems of expressly parallel programming, such as standard OpenMP, RapidMind platform, etc.), as well as automatic means of searching and identifying tasks suitable for parallel computations (e.g., compilers provided by Intel, Portland Group, etc.) and their subsequent representation using existing libraries that support parallel processing (MPI, libgomp, etc.).

Conventional explicit parallel programming and automatic parallelizing systems, taken independently from each other, have serious shortcomings. A compromise solution proposes creation of a system of implicit parallel programming. In this solution, a programmer, using traditional high level programming languages (C, C++, C#, Fortran, etc.), creates a program performing parallel calculations.

Automatic means should perform analysis and detect these parallel calculations. In case of problems with the analysis, the programmer can incorporate certain hints in the program for resolving interfering conflicts by a proper identification of tasks for parallel processing. Then, identified parallel calculations are automatically represented in parallel terms specific to a given hardware architecture. As a result, a system employs a certain interactive environment for development of parallel programs that balances the efforts of a human (i.e., a programmer) and the automatic means.

In such a system, the main work directed to the analysis, optimization and implementation of a parallel code is carried out by the computer automatically, while a programmer only resolves occasional conflicts that the machine's static analyzer was unable to handle. The inability to resolve conflicts automatically is based on two reasons: imperfection of the static analysis and the dynamic nature of these conflicts. In spite of the fact that the first factor will become less significant as better static analyzers are developed, the resolution of dynamic conflicts will still require programmer's intervention.

Accordingly, there is a need in the art for a system and method that allows the program to perform parallel operations automatically during the execution of the program for a wide variety of execution scenarios.

### SUMMARY OF THE INVENTION

The present invention is intended as a component-based method to creation of optimizing compilers.

The present invention develops a technique for porting of the components in a context of any existing technology of optimizing compilation. In one aspect of the invention there is provided a system, method, and computer program product for automatic generation of executable code for parallel execution based on the component approach described herein. According to an exemplary embodiment the method performs the following steps:

(a) automatically transforming program code to create multiple parallel execution loops on target hardware architecture;

(b) performing intra-procedural and inter-procedural optimization to maximize the number of multiple parallel execution loops;

(c) performing context-sensitive and control-flow-sensitive inter-procedural analysis of data flow to identify equivalent operations; and

(d) performing analysis of loop variables and dynamically checking effectiveness of performed optimization prior to committing optimized code for execution.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide further understanding of the invention and are incorporated in and constitute a part of this specification, illustrate embodiments of the invention and, together with the description, serve to explain the principles of the invention.

In the drawings:

FIG. 1 illustrates an algorithm for representation of operations;

FIG. 2 illustrates a dataflow graph in the form of a unique assignment;

FIG. 3 illustrates representation of a method for implementation of a canonical form;

FIG. 4 illustrates an example of creation of a canonical form for addition and multiplication operations;

FIG. 5 illustrates an algorithm for a dynamic check of efficiency for creation of modules for parallel execution; and

FIG. 6 illustrates a schematic of an exemplary computer system that can be used for implementation of the invention.

### DETAILED DESCRIPTION OF THE PREFERRED EMBODIMENTS

Reference will now be made in detail to the preferred embodiments of the present invention, examples of which are illustrated in the accompanying drawings.

### GLOSSARY OF TERMS

Intermediate representation of the program. The semantics of the program can be represented in an operational form. An element of this representation is an operation. An operation may be understood as any action upon surrounding context. All operations are ordered according to semantic dependences. For example, the program says c=a+b, an object “operation” appears in the intermediate representation, indicating that an addition of two arguments a and b is carried out and the result is recorded in c.

Basic block. A sequence of operations without internal branching and convergence of a control flow.

Control flow graph. The control flow graph of a procedure is an analytical structure of the data, a representation of results of the analysis of the topology and the semantics of the program. Each node of the control flow graph corresponds to some basic block. The control flow graph has certain orientation. Each arc of such a graph corresponds to a possibility of a transfer of control in the program between basic blocks. Each graph allocates a start node and a stop node. All other nodes of the graph can be reached from these two nodes.

Domination. A relation of domination is introduced between two nodes. The first node dominates the second node if all edges from the starting node to the second knot pass through the first node. A tree of dominators is constructed based on this relationship. The nodes of this tree are the nodes of the control graph, and the edges correspond to the domination relationship.

Loop tree. Program factorization, called a loop tree, is constructed based on the analysis of the control flow. This factorization is necessary for earmarking of the regions of the program, called loops, that present interest in terms of optimization of program regions. Loops are the nodes of the tree. The edges represent the enclosure of loops.

Dataflow graph. The dataflow graph is an analytical structure of the data in which the nodes are the operations, and the edges reflect the transfer of values between these operations. For a fragment of the program (1) c=a+b; (2) f=d−c, the two nodes, corresponding to the operations 1 and 2 will be connected by an edge in a dataflow graph which corresponds the transfer of data through a variable c.

The conflict. A concept of a conflict is introduced for two operations of memory access. The conflict means attempt to access to the same area of memory.

Dependence. A relationship of dependency is introduced for two operations of memory access. Dependence means the presence of a conflict and the ability to reach along the control flow graph.

Parallel loop. A loop that does not have cross-iterative dependences is called parallel loop.

Paralleling. Creation of executable program code for implementation of parallel processing.

Invariant variable. An invariant variable of a loop is the variable that does not change within this loop.

Inductive variable. An inductive variable is the variable of a loop that is incremented or decremented by a constant value for each iteration of the loop.

Recurrence. Recurrence is a sequence of operations that are connected cross-iteratively in a dataflow graph.

Reduction. Reduction is a variable which commutatively changes during each iteration of a loop.

In one embodiment static analyses of a program are performed. The key element of automatic parallelizer of program code for parallel processing is a static analyzer of algorithmic semantics of the programs, implemented on the basis of the analytical components of universal technology of optimizing translation. The analytical part includes new algorithms for analysis of the control flow, the analysis of the data flow, the inter-procedural analysis, the analysis of loop dependences, etc. These algorithms have been tested on industrial compilers and have proven to be highly efficient.

According to the exemplary embodiment, the following analytical components are included in the analyzer:
Analysis of the data flow using a Value Numbering method;
Analysis of a control flow (construction of a control flow graph, construction of dominator/post-dominator trees, construction of the loop tree, search of an iterative dominance frontiers, determination of control dependence equivalency);
Analysis of variables in a loop (recognition of invariants, inductive and reductive variables and recurrences);
Analysis of loop dependences;
Analysis of dependences in acyclic regions; and
Inter-procedural analysis of the data flow.

The primary task solved by the methods of static analysis of executable programs in the optimizing compilers is determination of the relationship of dependency with respect to data and control between various groups of calculations performed by the program. Effective and precise calculation of these relationships plays a decisive role in performing optimizing transformations of the program.

Therefore, in modern optimizing compilers, a major role is played by the analytical phases of compilation. Various phases of the analysis identify redundant calculations, dependences between operations of memory access, control dependencies, control flow reachability, etc. Within these phases, the control flow and the data flow in the program are analyzed, the systems of linear Diophantine equations and inequalities are solved for the purpose of defining the dependences in the cyclic regions of the program.

After the analysis of data and control flows, the compiler can use the results for obtaining the answers to the questions related to dependence between any pair of calculations in the program. The calculations, in this context, are understood to mean such elements of factorization on any level as operations, basic blocks, loops and procedures. Any inquiry about the relation of dependence has two dimensions of complexity which define the structure of constructing an answer. One of the dimensions considers complexity of calculations for which the dependency relation is defined, from the point of view of factorization of control flow, and the second defines the level of complexity of the objects of the program that are involved in the calculations being analyzed.

If the objects are elementary, the results of intra-procedural analysis of the control flow and data flows are sufficient to obtain the answer. As the complexity of the objects increases, the complexity of the analysis algorithms that are necessary to obtain the results needed to get the least conservative answer to the dependency question increases as well. For array objects, it is often necessary to apply the analysis of dependences in the loop nests, and for the objects that were indexed the results of inter-procedural analysis of the data flow are required.

The methods of the static analysis of the program play an especially important role for construction of the analyzer and the automatic parallelizer, for detection of the independent portions of the program (analyzer) and their further registration in the form of parallel blocks (parallelizer).

The exemplary embodiment performs substitution of intermediate representation of procedure in places of their class. Classical transformation (inline) occurs when an intermediate representation of a called procedure is substituted in place of the call operation. Due to this transformation, the analysis of the dependencies is simplified, since all the operations of the substituted procedure can be explicitly analyzed by the analysis algorithms.

During the substitution of calls, it is important to define the criterion according to which the transformation needs to be applied. In the exemplary embodiment, the criterion is chosen in such a way as to maximize the quantity of loops that do not contain calls. If substitution of a call does not lead to occurrence of new loops without calls, such a substitution is not implemented.

In the course of compilation, the program is transformed from the initial representation (for programming languages, it is the program source code) into an internal intermediate representation of the compiler. First of all, any intermediate representation used in the compilers preserves the semantics of the initial program. The semantics of the program is understood as its algorithmic essence.

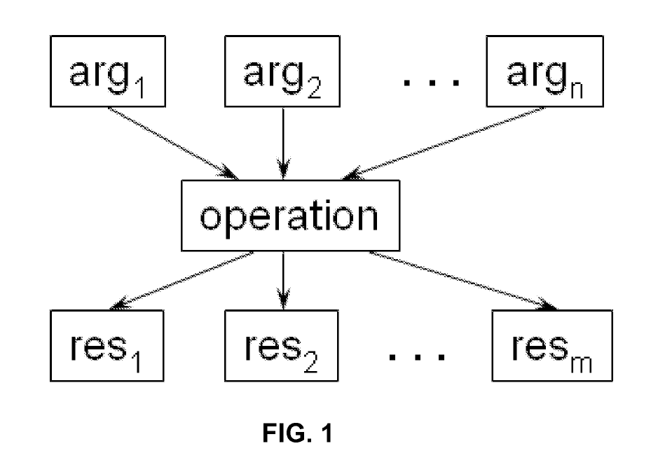

From the fragmentation point of view, the programs written in the most widespread programming languages (C, C++, C#, Fortran, etc.), are organized into modules and procedures. A module corresponds to the file organization of the programs. Various fragments of a program are implemented inside modules as procedures. The structures of the given programs are represented as objects with fixed or dynamically set sizes, the description of their internal structure is provided using types. The most general way of preservation of the algorithmic component of a program in the compilers is operational representation (FIG. 1).

Operational representation is the list of operations. An operation can have an input context and an output context. The input and output contexts are specified through the lists of arguments and results. These arguments can be literals, objects or references to other operations. Representation of a connection between the result of one operation and the argument of another through objects is more general than representation of this connection in a form of the reference to the operation.

The operation represents a set of attributes that define a semantic action over the input context to obtain the output context. Practically any known intermediate representation may be reduced to this operational representation, beginning with the syntactic trees of frontends (GCC, EDG), and ending with the representations most closely approximating the assemblers of a target architecture.

A sequence of transformations of the intermediate representation is carried out to perform the optimization in accordance with a chosen criterion. The described algorithm provides a sequence of steps that allows effective paralleling of loops in the program. The algorithm is started on the intermediate representation of the program. In the course of execution, the transformations of the intermediate representation are carried out. The intermediate representation is used during the application of transformations to construct (or use, if already constructed) the analytical structures of the data: the control flow graph, a tree of dominators, a loop tree, and the dataflow graph.

The exemplary embodiment performs an inter-procedural analysis of pointers that is necessary in order to determine, at the compilation stage of the program, the possible values of pointers contained in the variables in various parts of a program. Availability of such information helps to determine which groups of operations can be executed in parallel, which values have already been calculated and could be used again, allows to optimize memory accesses, and makes constant folding. Availability of the results of such analysis, possessing a high degree of detailed information, allows to effectively apply many optimizing transformations of the program both on intra- and inter-procedural level.

At a more formal level, the task of the inter-procedural analysis of pointers is calculation of some function that at each point of the program, for each variable, allows calculation of a set of values of one of listed above types that the variable can contain in this point. The problem of the inter-procedural analysis can be described by constructing such approximation of the semantics of the program that the program's behavioral property of interest would be reflected at the execution stage.

The approach to the problem of inter-procedural analysis of the data flow offered here is described using such characteristics as sensitivity to the control flow (flow-sensitivity) and sensitivity to a context of a call procedure (context-sensitivity). The first characteristic means that the algorithm is taking into consideration the control flow inside the procedure, which leads to an increase in its accuracy.

The second characteristic means that it aims to distinguish the information coming into the procedure during its execution via different paths. However, since the number of such routes can be considerable, it is necessary to combine those of them that are presumably the closest, and where such combining brings in the minimum possible conservatism in its results.

The basic mechanism that is usually used to insure contextual dependency is the mechanism of a partial transfer functions (PTF). It allows choosing, rather effectively, a balance between the speed of performing the analysis and its accuracy, since, in general, the process of inter-procedural analysis of the data flow consumes substantial resources, both in terms of the memory required and in terms of time required for its completion.

The exemplary embodiment implements a method for data flow analyses using Value Numbering (VN). The data flow analysis in the program using the method of Value Numbering (VN) consists of assigning to the results of operations identical classes of equivalence if these operations write equivalent values into these results. Two operations are considered equivalent if their arguments are equivalent and if these operations perform the same semantic action. During the flow analysis, a dataflow graph is build, for connecting the results and the arguments of operations.

The dataflow graph allows obtaining for the arguments the operations producing the value of the argument. Another analytical method used is a method using a Static single assignment (SSA) form. The source code Intermediate representation of the program translated into this form contains pseudo-operations at the convergence points of the control flow.

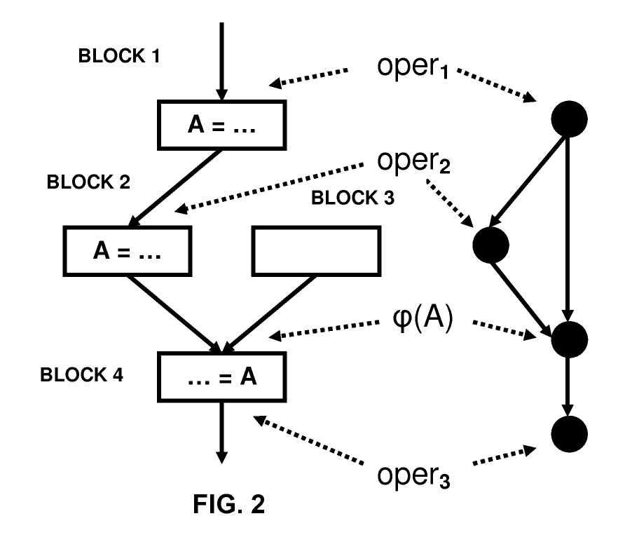

As a result, taking into account these pseudo-operations, for each argument for which the transfer into the form of unique assignment is performed, there is only one record. Accordingly, in the dataflow graph for such arguments there will be only one entrance edge from this record. FIG. 2 shows a dataflow graph in the SSA form. The program used in the example depicted in FIG. 2 has instances of writing into variable A and one instance of reading. Writing is designated as ‘A= . . . ’, and reading is designated as ‘ . . . =A’.

The rectangles and arrows connecting them show the control flow in the program. Transfer of Control flow from block BLOCK 1 is possible to either block BLOCK 2 or to block BLOCK 3. From blocks BLOCK 2 and BLOCK 3 the Control flow is transferred to block BLOCK 4. Black circles and arrows that connect them form a dataflow graph for the given fragment of the program. On the dataflow graph, each node corresponds to an operation, and each edge corresponds to an argument-result pair. The pseudo-operation corresponding to a convergence of a Control flow is designated as ‘φ(A)’.

The exemplary embodiment performs analysis of loop variables for invariance, inductance and reduction. Search of loop variables is performed using the dataflow graph. The analysis consists of searching for the sub-graphs, satisfying the conditions of invariance, inductance and reduction.

The exemplary embodiment also performs analyses of operations of access to arrays. Substantial improvement of quality of the Control flow analysis using the method of Value Numbering can be achieved through the use a canonical form of representation of expressions as sums of products. This form is one of the methods of representation of linear expression in a polynomial form:

c₀+c₁*x₁₁*x₁₂* . . . *x₁ₖ₁+c₂*x₂₁*x₂₂* . . . *x₂ₖ₂+ . . . +cₙ*xₙ₁*xₙ₂* . . . *xₙₖₙ, where c₀, c₁, cₙ are constants, and xᵢⱼ are multipliers.

The effect of using a canonical form is that the linear expressions are reduced to a uniform (canonical) representation, which allows identifying the equivalent calculations even if the initial forms of expressions are different. The constant folding (execution of arithmetic operations on the constants), ordering of commutative operations and the reduction of identical summands are performed within the framework of reduction of arithmetic expressions to a canonical form. For example, the expression (a+b)*c and the expression a*c+b*c will be reduced to a uniform expression a*c+b*c and determined to be equivalent.

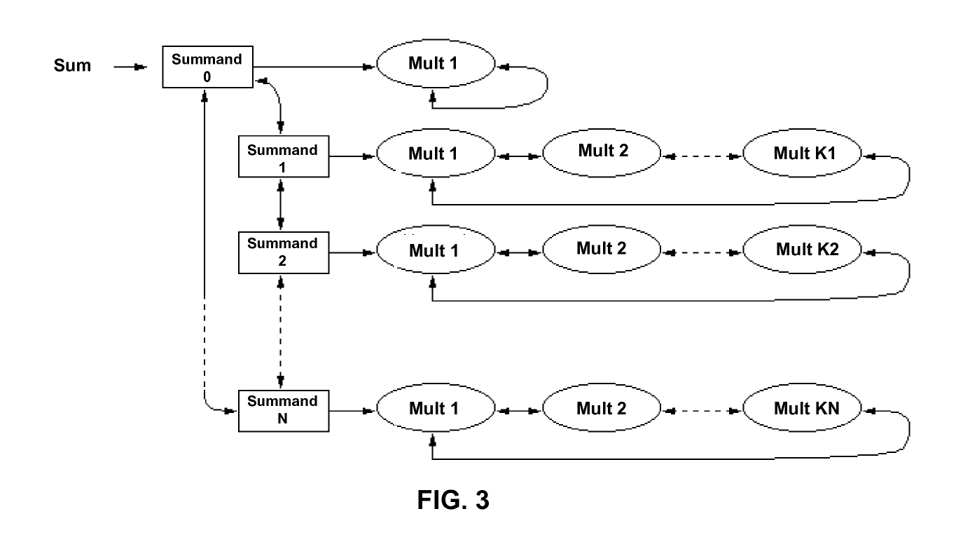

FIG. 3 shows the structure of a method for implementation of the shown canonical form. The elements corresponding to the summands are shown in the rectangles. The elements corresponding composed are presented. The multipliers are shown in the ovals.

The mechanism of use of a canonical form during the execution of the algorithm of numberings of values is essentially constructing the sum of products from the arguments of operations of addition, subtraction and multiplication. The multipliers in the canonical form will be the classes of equivalence. The hashing of the operations for which the construction of canonical forms is possible is performed on the basis of these forms.

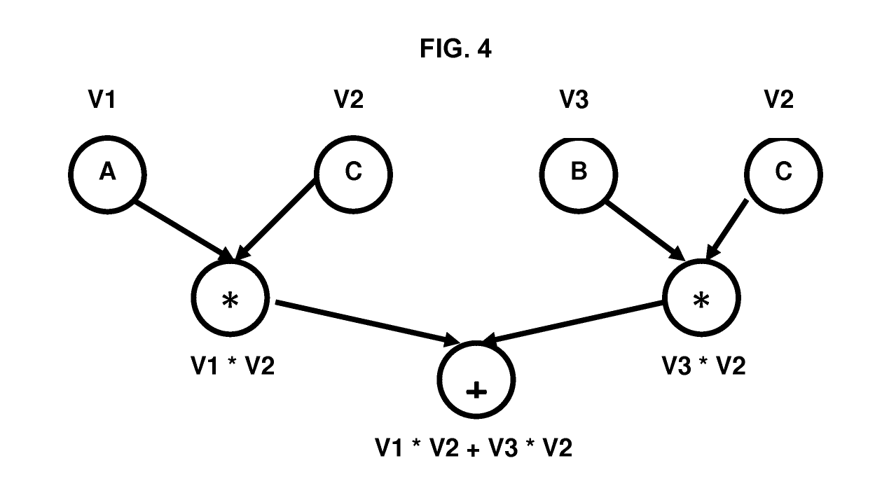

FIG. 4 shows an example of construction of a canonical form for the operations of addition and multiplication. The symbols V1, V2 and V3 designate the classes of equivalence for operations of reading from variables A, C and B accordingly.

One method of representation of addresses of operations of accessing memory is in a canonical form of the sums of products where the multipliers are chosen as the classes of equivalence, calculated as a result flow analysis using the method of Value Numbering. The analysis of dependences in the cyclical regions is basically reduced to the analysis of conflicts of operations of memory access.

The most widely known method of working with memory is referring to arrays using linear pointers. A fragment of a program written in C language is shown below.

1: int A [10];
2: j = 1;
3: for (i = 1; i <10; i++)
4: {
5: A [i + 1] = 2*A [j − 1];
6: j ++;
7: }

Line 1 declares an array of 10 elements in size. Line 5 sets the reference to the array using pointers i+1 and j−1. A certain class of equivalency V is assigned to the operations of reading from the variable i. A canonical form 1+V is then constructed for the index i+1. The same class of equivalency V is assigned to the operation of reading from variable j, since both variables i and j contain the same values.

A canonical form −1+V is constructed for the index of access to array j−1. Then the equations 1+V=−1+V′ is solved to determine the dependences, where the variables V and V′ have the restrictions 0<V<10 and 0<V′<10. Variables V and V′ are the numbers of the iteration of the loop. The iterations on which a reference is made to the same element A of the array are determined as a result of solving of the system of equations and inequalities.

The exemplary embodiment implements loop fusion. Loop fusion optimization is performed to increase the number of calculations occurring during one iteration of a loop and to reduce the required resources to implement paralleling. One example of loop fusion is provided below. The resources required for paralleling after the transformation are cut in half, since the operation of paralleling is performed only for one loop instead of two.

| Before the transformation | After the transformation |
|---|---|
| int i; | int i; |
| int A [10]; | int A [10]; |
| int B [10]; | int B [10]; |
| for (i = 0; i <10 i ++) | for (i = 0; i <10 i ++) |
| { | { |

| | |
|---|---|
| A [i] = 0; | A [i] = 0; |

| | |
|---|---|
| } | B [i] = 0; |

| | |
|---|---|
| for (i = 0; i <10; i ++) | } |
| { | |

B [i] = 0;

}

The exemplary embodiment implements switching off invariant conditions. An optimization, by taking out of invariant conditions from a loop, allows elimination from the loop of operations that are executed under these conditions. The operations interfering with paralleling may end up among the operations that have been taken out. Call operations, in particular, fall into this category. Because of that, this transformation increases the number of loops.

Changing the order of traversal of the iteration space.

This optimization aimed at both increasing the number of parallelized loops, and to improve the efficiency of parallelization. Another term for these transformations is “unimodular transformation.”

Analysis of cross-iterative dependencies.

The task of finding cross-iterative dependencies is to solve the system of linear Diophantine equations and inequalities. The equations are a result of comparison of indices of access to an array, and the inequality form of representation of the upper and lower bounds on the variables of cycles in mathematical form. The number of equations is determined based on the dimension of arrays, whose access operations are defined at the stage of task definition.

Once the task is defined, the following sequence of steps is performed:

Solving the system of linear Diophantine equations. If the system of equations has no solution, then, the relationship does not exist. If the system of equations has a solution, examine the system of linear Diophantine inequalities. If the system of Diophantine inequalities has a solution, this means that the relationship exists. If there is no solution, the dependency does not exist. If dependence exists, then the vector directions and vector distances are examined.

The classical approach to solving systems of linear Diophantine inequalities is to use the Fourier method.

The exemplary embodiment also implements analyses of arrays for localization. If an array, for each iteration of a loop, and before reuse, is rewritten with new values and is not used after the loop, it is possible for each iteration to create a local copy of such an array. This transformation is called localization and allows removing cross-iterative dependences of the initial array.

Therefore, in order to localize an array, it is necessary to make sure that on every path of the loop, from the beginning of a loop to the operations of reading from the array, there is an operation of writing into the same elements of the array. In addition, it is necessary to check that the array is not used after the loop. This action allows eliminating cross-iterative dependences in a loop, thereby increasing the possibilities for paralleling.

Yet another operation of the exemplary embodiment is loop duplication. The method of loop duplication is used to check the efficiency of implementation of paralleling. One copy is left without implementing paralleling and implementing paralleling on another copy. A check performed before the loops determine the expediency of a transition to a paralleled loop or of keeping the initial version of a loop. The time required for the execution of iterations is compared to the cost of resources for starting a parallel loop.

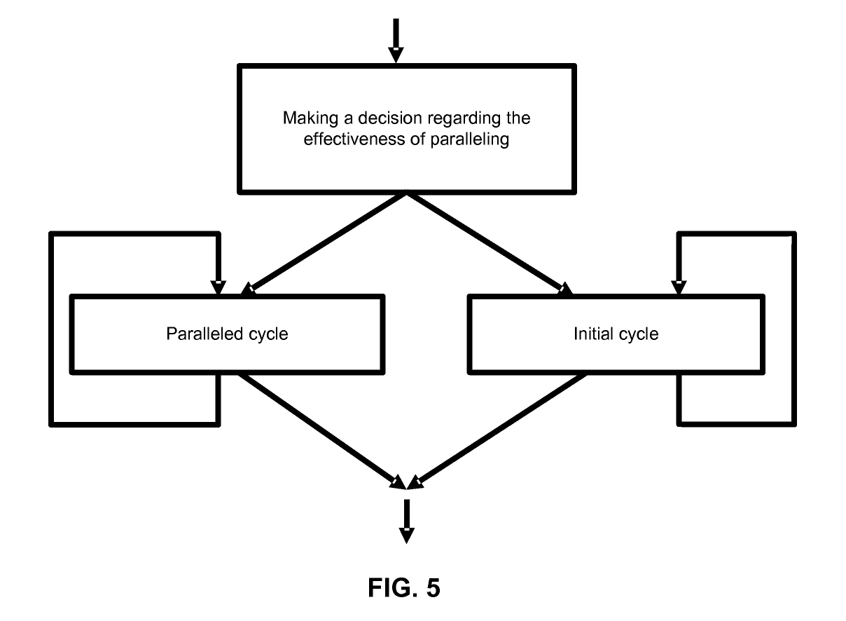

FIG. 5 shows an example of such transformation. In one embodiment, the following method is implemented. At the stage of intermediate program representation, at least following analytical structures of the data are constructed (or used, if constructed previously): a control flow graph, a tree of dominators, a loop tree, a dataflow graph, created by any known means. The step-by-step description of the method is provided below.

First, substitute the bodies of the procedures in places where they are called. In case of paralleling, this action is directed to the analysis of loops that call other procedures. In the presence of these calls, the known techniques of the analysis of dependences in loops are inapplicable.

Second, perform the inter-procedural analysis of the data flow. The method of partial transfer functions is used for the analysis of pointers. Various alternative ways to perform this analysis may be used as well.

Third, perform the intra-procedural analysis of the data flow, using mainly the method of Value Numbering. The purpose of this analysis is to identify equivalent operations. It is also possible to use the classical iterative algorithms of distribution of the flow properties of the program.

Fourth, perform the Loop variable analysis. Identify the invariant variables, inductive variables and reductions. For example, perform the analysis of a dataflow graph with definition of the sub-graphs corresponding to the inductive and/or invariant variables.

Fifth, perform the analysis of operations of access to the arrays. Build pointers of access to the arrays in the canonical form of the sums of products.

Sixth, perform the transformation of loops to increase the effect from subsequent paralleling, including such transformations as loop fusion, unswitching and unimodular transformations.

Seventh, perform the analysis of parallel loops. A loop tree is explored recursively from the root node, checking for a possibility of paralleling of the current cycle. Perform at least the following types of analysis:

a. The analysis of the structure of a loop. The loops that lend themselves to paralleling are the loops with one exit, the control of which is performed using an inductive variable with invariant upper and lower boundaries and an invariant step.

b. The analysis of reductions of a loop. The recognized reductions are excluded during the analysis of cross-iterative dependences.

c. The analysis of cross-iterative dependences in a loop. Cross-iterative dependences are identified using the classical method of solving Diophantine equations.

d. The analysis of arrays for locality. In case of localization of the arrays, the cross-iterative dependences can be removed.

A copy of a loop is constructed for the parallel loops, since the paralleled loop does not always work faster than an initial loop. Under certain conditions, the requirement of additional resources in order to start the loop in the parallel mode may lead to a decline of productivity. The time required for execution of iterations is dynamically compared with the additional resources necessary to start the loop in a parallel mode.

For parallel loops, the operations are constructed to provide for parallel execution of these loops. During the parallel execution, several streams of execution are started, each of which performs a portion of the iterations of the loop. The body of a loop is allocated into a new procedure, with non-local data of loop iterations as the parameters. The local data structures of the iterations of the initial loop are allocated to the local data structures of the created procedure.

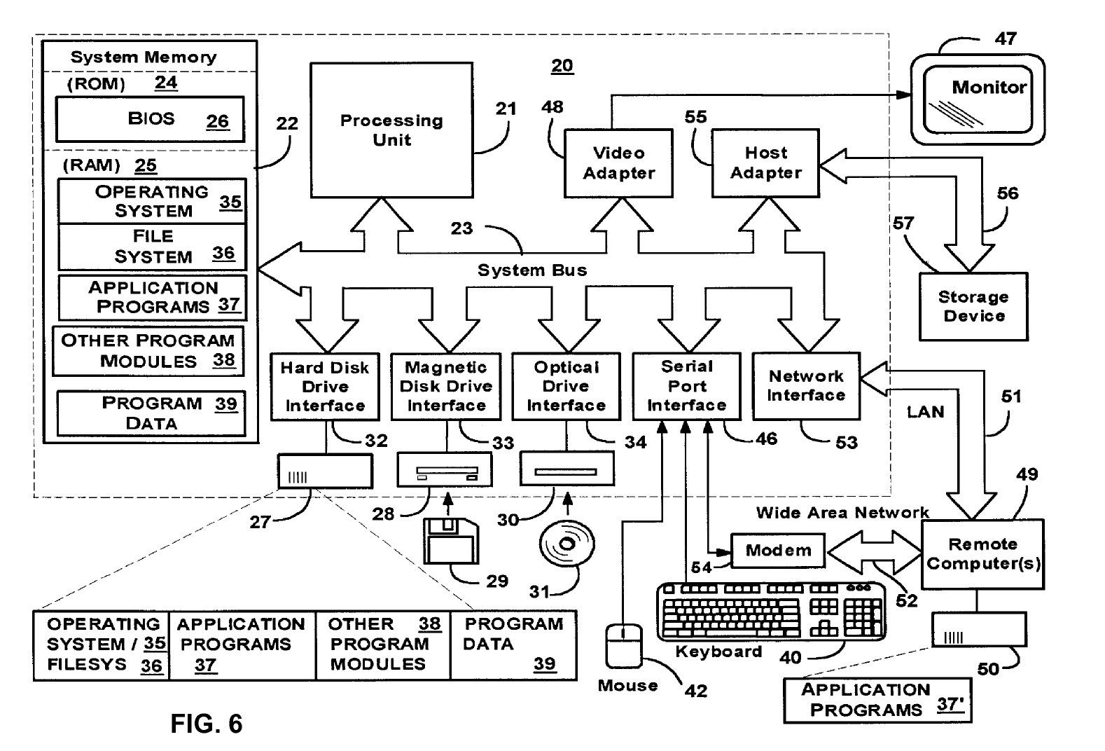

With reference to FIG. 6, an exemplary system for implementing the invention includes a general purpose computing device in the form of a computer or server 20 or the like, including a processing unit 21, a system memory 22, and a system bus 23 that couples various system components including the system memory to the processing unit 21.

The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system 26 (BIOS), containing the basic routines that help transfer information between elements within the computer 20, such as during start-up, is stored in ROM 24.

The computer 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD-ROM, DVD-ROM or other optical media.

The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide non-volatile storage of computer readable instructions, data structures, program modules and other data for the computer 20.

Although the exemplary environment described herein employs a hard disk, a removable magnetic disk 29 and a removable optical disk 31, it should be appreciated by those skilled in the art that other types of computer readable media that can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules may be stored on the hard disk, magnetic disk 29, optical disk 31, ROM 24 or RAM 25, including an operating system 35. The computer 20 includes a file system 36 associated with or included within the operating system 35, one or more application programs 37, other program modules 38 and program data 39. A user may enter commands and information into the computer 20 through input devices such as a keyboard 40 and pointing device 42. Other input devices (not shown) may include a microphone, joystick, game pad, satellite dish, scanner or the like.

These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48. In addition to the monitor 47, personal computers typically include other peripheral output devices (not shown), such as speakers and printers.

The computer 20 may operate in a networked environment using logical connections to one or more remote computers 49. The remote computer (or computers) 49 may be another computer, a server, a router, a network PC, a peer device or other common network node, and typically includes many or all of the elements described above relative to the computer 20, although only a memory storage device 50 has been illustrated. The logical connections include a local area network (LAN) 51 and a wide area network (WAN) 52. Such networking environments are commonplace in offices, enterprise-wide computer networks, Intranets and the Internet.

When used in a LAN networking environment, the computer 20 is connected to the local network 51 through a network interface or adapter 53. When used in a WAN networking environment, the computer 20 typically includes a modem 54 or other means for establishing communications over the wide area network 52, such as the Internet.

The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing a communications link between the computers may be used.

Having thus described a preferred embodiment, it should be apparent to those skilled in the art that certain advantages of the described method and apparatus can be achieved.

It should also be appreciated that various modifications, adaptations and alternative embodiments thereof may be made within the scope and spirit of the present invention. The invention is further defined by the following claims.

What is claimed is:

1. A computer-implemented method for optimization of executable code during a compilation stage, the method comprising:
(a) storing a program executable code in memory;
(b) automatically transforming program executable code stored in the memory to create multiple parallel execution loops using canonical forms;
(c) implementing the parallel execution loops on target architecture;
(d) performing intra-procedural and inter-procedural optimization to maximize a number of multiple parallel execution loops using the canonical forms;
(e) performing context-sensitive and control flow-sensitive cross-procedural analysis of data flow to identify equivalent operations; and
(f) performing analysis of loop variables and dynamically checking effectiveness of performed optimization prior to committing optimized code for execution on a processor.

2. The method of claim 1, wherein an intermediate representation of the program code is created by substitution of procedure calls with the corresponding procedure code.

3. The method of claim 1, wherein a modified representation of the parallel loops code is created and dynamically compared for effectiveness of execution to the parallel loop's code before modification.

4. The method of claim 3, wherein the parallel loop code is allocated into a new procedure with non-local data of loop iterations as procedure parameters.

5. The method of claim 4, wherein the parallel loop's local data structures are allocated to local data structures of the new procedure.

6. The method of claim 1, wherein the inter-procedural optimization comprises dataflow analysis using partial transfer functions.

7. The method of claim 1, wherein the intra-procedural optimization comprises dataflow analysis using Value Numbering to determine equivalent operations.

8. A non-transitory computer useable storage medium having computer executable program logic stored thereon, the computer executable program logic executing on a processor for implementing the steps (b)-(f) of claim 1.

9. A system for optimization of executable code during the compilation stage, the system comprising:
a processor coupled to processing hardware;
a memory coupled to the processor;
data flow stored in the memory;
an executable code stored in the memory and executed on the processor,
wherein:
the executable code in the memory is transformed to create multiple parallel execution loops using canonical forms and distributes the parallel execution loop code to target architecture;
intra-procedural and inter-procedural optimization is performed to maximize the number of multiple parallel execution loops using the canonical forms;
a set of equivalent operations identified through context-sensitive and control flow-sensitive inter-procedural analysis and stored in the memory; and
wherein an analysis of loop variables is performed to dynamically check effectiveness of performed optimization prior to committing optimized code for execution.

10. The system of claim 9, wherein an intermediate representation of the program code is created by substitution of procedure calls with the corresponding procedure code.

11. The system of claim 9, wherein a modified representation of the parallel loops code is created and dynamically compared for effectiveness of execution to the parallel loop's code before modification.

12. The system of claim 11, wherein the parallel loop code is allocated into a new procedure with non-local data of loop iterations as procedure parameters.

13. The system of claim 12, wherein the parallel loop's local data structures are allocated to local data structures of the new procedure.

14. The system of claim 9, wherein the inter-procedural optimization comprises dataflow analysis using partial transfer functions

15. The system of claim 9, wherein the intra-procedural optimization comprises dataflow analysis using Value Numbering to determine equivalent operations.
